(19) United States
(12) Patent Application Publication
(10) Pub. No.: US 2025/0207446 A1
(43) Pub. Date: Jun. 26, 2025

(54) GUIDE RAIL FOR A SLIDING DOOR WITH A GUIDE ELEMENT

(71) Applicant: Häfele SE & Co KG, Nagold (DE)

(72) Inventor: Lajos Bartoss, Budapest (HU)

(73) Assignee: Häfele SE & Co KG, Nagold (DE)

(21) Appl. No.: 19/078,144

(22) Filed: Mar. 12, 2025

Related U.S. Application Data
(63) Continuation of application No. PCT/EP2023/075411, filed on Sep. 15, 2023.

(30) Foreign Application Priority Data
Sep. 16, 2022 (DE) 20 2022 105 238.7

(51) Int. Cl. E05D 15/10

(52) U.S. Cl. CPC E05D 15/1042; E05D 2015/1026; E05D 2015/1055; E05Y 2201/47; E05Y 2900/20

(57) ABSTRACT

A guide rail for a sliding door with a guide element includes a guide channel, which extends along a center axis and in which the guide element of the sliding door can be guided, a holding portion, and a diverter element which can be pivoted about a pivot axis into an open position and into a closed position. The diverter element divides the guide channel into a first channel region and a second channel region in the open position. The first channel region is connected to the holding portion in such a way that the guide element of the sliding door can be transferred from the first channel region into the holding portion. The diverter element releases the guide channel in the closed position in such a way that the first channel region is connected to the second channel region.

### CROSS-REFERENCE TO RELATED APPLICATIONS

This continuation application claims priority to PCT/EP2023/075411 filed on Sep. 15, 2023 which has published as WO 2024/056849 A1 and also the German application number DE 20 2022 105 238.7 filed on Sep. 16, 2022, the entire contents of which are fully incorporated herein with these references.

### DESCRIPTION

### Field of the Invention

The present invention relates to a guide rail for a sliding door with a guide element, in particular for a furniture item.

### Background of the Invention

Guide rails for sliding doors have the task of guiding the movement of the sliding door from a first position, in which the sliding door is open, toward a second position, in which the sliding door is closed. In addition, guide rails can assume the task of supporting sliding doors and in the process of supporting the weight which acts on sliding doors.

DE 29 12 256 C2 discloses a guide rail, on which two sliding doors are guided which lie in a common plane in the closed state. The guide rail comprises a center diverter, via which the two sliding doors are guided and which can be pivoted in such a way that the two sliding doors lie in planes which are arranged parallel to one another and can be guided past one another. The plane in which the sliding doors lie in the open state intersects the plane in which the sliding doors lie in the closed state. The sliding doors are each guided via two guide rollers of the guide rail and the center diverter, which guide rollers engage into a groove of the sliding doors.

### SUMMARY OF THE INVENTION

Proceeding here from, the present invention is based on the object of providing a guide rail for a sliding door with a guide element, which guide rail makes stable guidance of the sliding doors possible.

The object on which the present invention is based is achieved by a guide rail for a sliding door with a guide element, comprising: a guide channel which extends along a center axis and in which the guide element of the sliding door can be guided, a holding portion, a diverter element which can be pivoted about a pivot axis into an open position and into a closed position, wherein the diverter element divides the guide channel into a first channel region and a second channel region in the open position, wherein the first channel region is connected to the holding portion in such a way that the guide element of the sliding door can be transferred from the first channel region into the holding portion, and the diverter element releases the guide channel in the closed position in such a way that the first channel region and the second channel region are connected to one another.

The guide rail according to the invention has the advantage that the guide element of the sliding door is guided in a stable manner within the guide channel and can be transferred in a stable manner from the guide channel into the holding portion via the diverter element.

The guide rail can be configured, in particular, for at least one sliding door with at least one guide element. The at least one guide element can be configured as a guide roller. Here, the rotational axis of the guide roller can be arranged parallel to the pivot axis of the diverter element.

Specifically, the guide rail can be configured for at least one sliding door with two guide elements each in the form of a guide roller. Here, the rotational axis of the two guide rollers can each be arranged parallel to the pivot axis of the diverter element.

In one possible embodiment of the guide rail according to the invention, the guide channel can be divided into the first channel region and the second channel region in the open position of the diverter element in such a way that the guide element cannot be transferred from the first channel region into the second channel region. In other words, the guide channel can be divided into the first channel region and the second channel region in the open position of the diverter element in such a way that a transfer of the guide element from the first channel region into the second channel region is blocked.

In a further possible embodiment, the diverter element can be pivotable from the open position into the closed position by way of the guide element. In particular, the diverter element can be pivotable from the open position into the closed position during the transfer of the guide element from the guide channel into the holding portion.

In addition, one embodiment is possible in which the pivot axis of the diverter element is arranged in a skewed manner with respect to the center axis of the guide channel. In particular, the pivot axis of the diverter element can be arranged in a skewed and orthogonal manner with respect to the center axis of the guide channel. In one possible embodiment, the pivot axis of the diverter element can be arranged outside the guide channel.

In one possible refinement of the guide rail according to the invention, the diverter element can comprise a separating portion which is arranged in the guide channel in the open position and forms a portion of a wall of the guide channel in the closed position. Here, the separating portion can have a concave transfer surface and a straight channel wall surface. Here, in the open position, the concave transfer surface can delimit a transfer channel, via which the guide element can be transferred from the guide channel into the holding portion. As an alternative or in combination with this, the straight channel wall surface can form the portion of the wall of the guide channel in the closed position.

In a further possible refinement, the diverter element can comprise an actuating portion which is arranged outside the guide channel in the open position and delimits the holding portion in the closed position. Here, the actuating portion can have a concave transfer surface and a straight holding portion bounding surface. Together with the concave transfer surface of the separating portion, the concave transfer surface of the actuating portion can form an actuating contour which delimits the transfer channel in the open position. The straight holding portion bounding surface can delimit the holding portion in the closed position.

The diverter element can be of L-shaped configuration. Here, the separating portion can be arranged transversely with respect to the actuating portion. In particular, a longitudinal axis of the separating portion can be arranged at a right angle with respect to the longitudinal axis of the actuating portion.

In a further possible refinement, a first spring element can be provided which loads the diverter element with a first spring force, with the result that the diverter element is pivoted into the open position by the first spring force. The first spring element can be configured, for example, as a spiral spring, a torsion spring, a compression spring or a tension spring.

In a further possible refinement, a second spring element can be provided which is in contact with the diverter element in the open position of the diverter element in such a way that the diverter element is held in the open position by the second spring element. As an alternative or in combination, the second spring element can be in contact with the diverter element in the closed position of the diverter element in such a way that the diverter element is held in the closed position by the second spring element. Here, the second spring element can be in contact with the diverter element in such a way that a frictionally locking or a positively locking connection is established between the second spring element and the diverter element.

A frictional force can act between the second spring element and the diverter element at least in portions over the pivoting path of the diverter element from the closed position into the open position, which frictional force can also be called a damping force with regard to the pivoting movement of the diverter element. In addition, it is possible in one refinement that the second spring force of the second spring element can be varied by way of the guide element during the transfer of the guide element from the guide channel into the holding portion.

In one possible embodiment, the second spring element can have a hook portion which is in contact with the diverter element in the open position of the diverter element in such a way that the diverter element is held in the open position by the hook portion. As an alternative or in combination, the hook portion can be in contact with the diverter element in the closed position of the diverter element in such a way that the diverter element is held in the closed position by the hook portion. Here, the second spring element can be configured as a spring clip which has the hook portion at a free end. The guide rail can comprise the first spring element and the second spring element in combination. As an alternative, it is also conceivable that the guide rail comprises one of the first spring element and the second spring element.

In one possible embodiment of the guide rail according to the invention, the holding portion can be arranged in a radial overlap with respect to the guide channel. The arrangement of the holding portion in the radial overlap with respect to the guide channel is intended to be understood here in such a way that the holding portion is arranged at least partially in a plane which is arranged at a right angle with respect to the center axis of the first guide channel.

It can be provided in a further possible embodiment that a guide element of a further sliding door can be guided in the guide channel in such a way that a further holding portion is provided, that a further diverter element is provided which can be pivoted about a further pivot axis into an open position and into a closed position, wherein the pivoting from the open position into the closed position in the case of the further diverter element takes place in the opposite direction to the pivoting of the diverter element, that the diverter element divides the guide channel into a third channel region and a fourth channel region in the open position, wherein the third channel region is connected to the further holding portion in such a way that the guide element of the further sliding door can be transferred from the third channel region into the further holding portion, and that the further diverter element releases the guide channel in the closed position in such a way that the third channel region is connected to the fourth channel region, wherein, in particular, the guide element of the sliding door can be guided from the third channel region into the fourth channel region.

In a further possible embodiment, the guide channel can be divided by way of the further diverter element into the third channel region and the fourth channel region in the open position in such a way that the guide element of the further sliding door cannot be transferred from the third channel region into the fourth channel region.

In a further possible embodiment, a further guide channel can be provided which has a center portion which is arranged parallel to and spaced apart from the center axis of the one guide channel, and a first end portion and a second end portion which are each arranged spaced apart from and transversely with respect to the center axis of the one guide channel, wherein a further guide element of the sliding door can be guided in the further guide channel and/or a further guide element of the further sliding door can be guided in the further guide channel.

One exemplary embodiment will be explained in the following text on the basis of the figures, in which:

### BRIEF DESCRIPTION OF THE DRAWINGS

FIG. 1 shows a view of a bottom of a furniture item with a guide rail according to the invention, wherein a first sliding door and a second sliding door are each shown in a closed position;

FIG. 2 shows the guide rail from FIG. 1, wherein a first sliding door is shown in a partially open position and a second sliding door is shown in a closed position;

FIG. 3 shows the guide rail from FIG. 1, wherein the first sliding door is shown in an open position and the second sliding door is shown in a closed position;

FIG. 4 shows the rail center module of the guide rail from FIG. 1, wherein a first diverter element and a second diverter element are each arranged in the closed position;

FIG. 5 shows the rail center module of the guide rail from FIG. 1 together with the first and the second sliding door in each case in a closed position;

FIG. 6 shows the rail center module of the guide rail from FIG. 1 together with the first sliding door in a partially open position and the second sliding door in a closed position;

FIG. 7 shows the rail center module of the guide rail from FIG. 1 together with the first sliding door in an intermediate position and the second sliding door in a closed position;

FIG. 8 shows a cross section through the guide rails from FIG. 1 along the sectional plane VIII-VIII from FIG. 7, wherein the first guide roller of the first sliding door and the first holding element of the second sliding door are arranged in the sectional plane;

FIG. 9 shows a section through the hook portion of the second spring element with the diverter element in the closed position; and

FIG. 10 shows a section through the hook portion of the second spring element with the diverter element in the open position.

### DETAILED DESCRIPTION OF EMBODIMENTS OF THE INVENTION

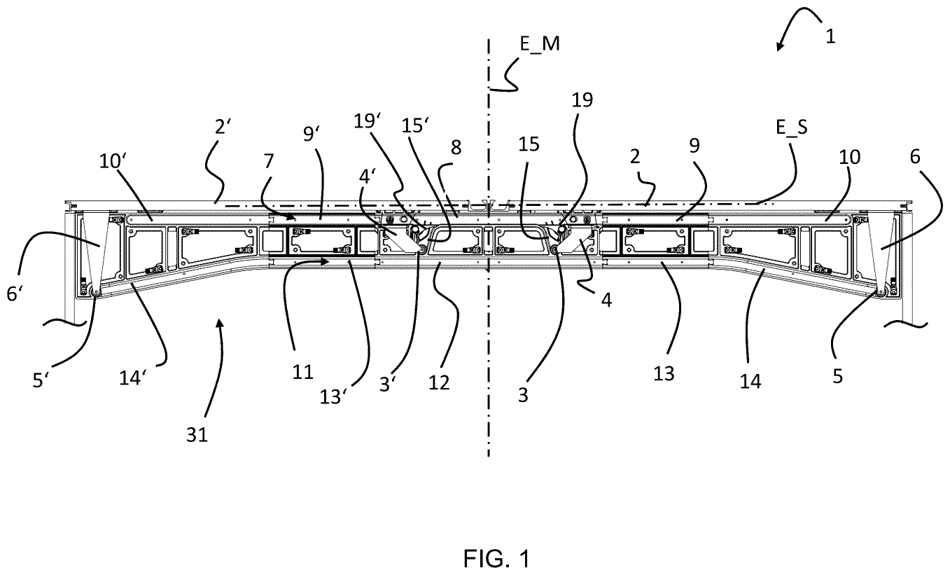

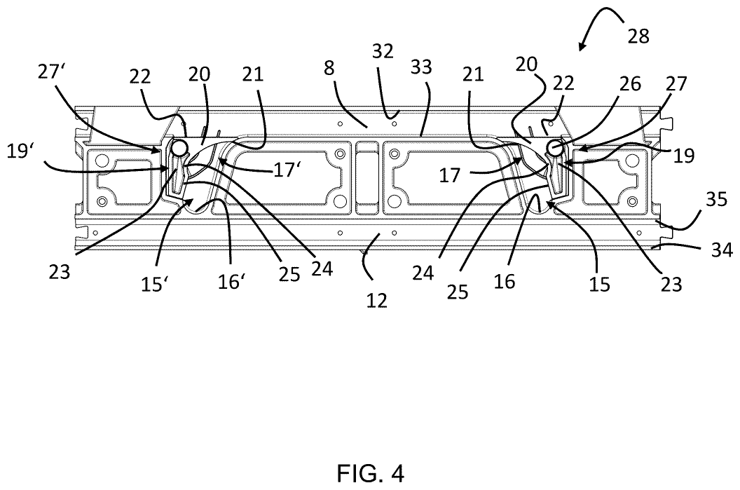

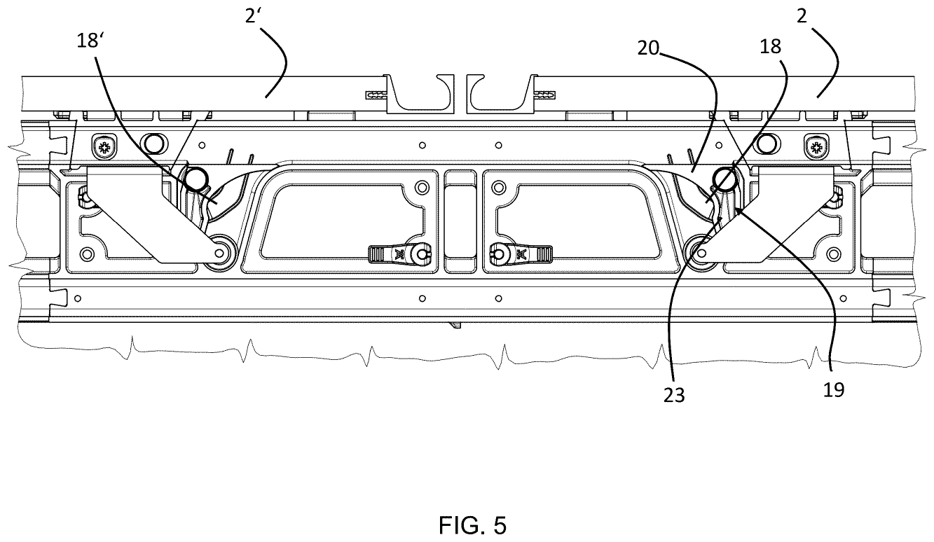

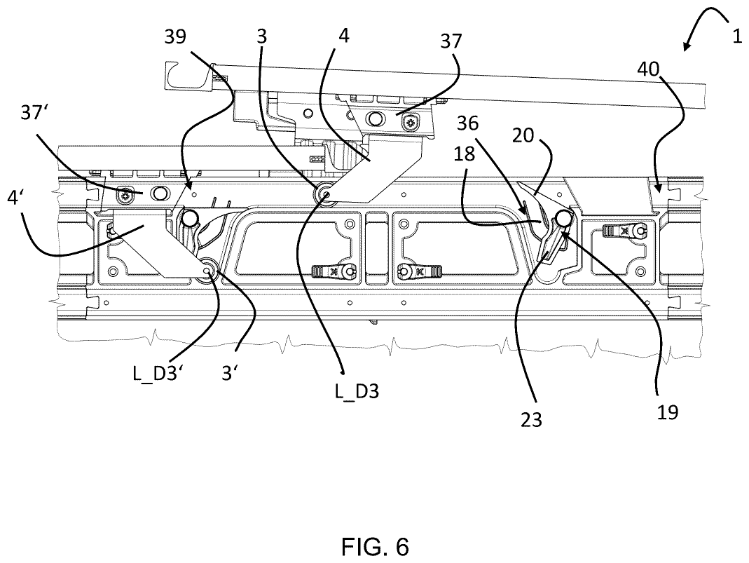

FIGS. 1 to 10, which will be described jointly in the following text, show a guide rail 1 according to the invention which is fastened to a bottom of a furniture item 31. In the present case, this is the lower bottom of the furniture item 31, wherein it is also conceivable that the guide rail 1 is fastened to an upper bottom of the furniture item 31. The guide rail 1 is configured here to guide a first sliding door 2 and a second sliding door 2′. The first sliding door 2 and the second sliding door 2′ can each be guided here via the guide rail 1 from a closed position, in which the respective sliding door closes a part of the furniture item 31 which is assigned to the sliding door, into an open position, in which the respective sliding door releases that part of the furniture item which is assigned to the sliding door. In the completely closed position, the first sliding door 2 and the second sliding door 2′ each lie in a closing plane E_S. In the completely open position, the first sliding door 2 lies in a first opening plane E_O, and the second sliding door lies in a second opening plane. The first opening plane E_O and the second opening plane lie in the same plane in the present case, without being restricted hereto. In the present case, the first opening plane E_O and the second opening plane are arranged parallel to and spaced apart from the closing plane E_S. It is also conceivable, however, that the first opening plane E_O and the second opening plane are arranged transversely with respect to the closing plane E_S and, in particular, enclose an acute angle.

The first sliding door 2 comprises a first guide element 3 in the form of a guide roller which is connected via a first holding element 4 to the first sliding door 2. In addition, the first sliding door 2 comprises a second guide element 5 which is connected via a second holding element 6 to the first sliding door 2. The first guide element 3 of the first sliding door 2 has a rotational axis L_D3 which is arranged parallel to and, in particular, spaced apart from the first sliding door 2. In addition, the rotational axis L_D3 of the first guide element 3 of the first sliding door 2 is arranged parallel to and, in particular, spaced apart from the closing plane E_S. The second guide element 5 of the first sliding door 2 has a rotational axis L_D5 which is arranged parallel to and, in particular, spaced apart from the first sliding door 2. In addition, the rotational axis L_D5 of the second guide element 5 of the first sliding door 2 is arranged parallel to and, in particular, spaced apart from the closing plane E_S.

The second sliding door 2′ comprises a first guide element 3′ in the form of a guide roller which is connected via a first holding element 4′ to the second sliding door 2′. In addition, the second sliding door 2′ comprises a second guide element 5′ which is connected via a second holding element 6′ to the second sliding door 2′. The first guide element 3′ of the second sliding door 2′ has a rotational axis L_D3′ which is arranged parallel to and, in particular, spaced apart from the second sliding door 2′. In addition, the rotational axis L_D3′ of the first guide element 3′ of the second sliding door 2′ is arranged parallel to and, in particular, spaced apart from the closing plane E_S. The second guide element 5′ of the second sliding door 2′ has a rotational axis L_D5′ which is arranged parallel to and, in particular, spaced apart from the second sliding door 2′. In addition, the rotational axis L_D5′ of the second guide element 5′ of the second sliding door 2′ is arranged parallel to and, in particular, spaced apart from the closing plane E_S.

The guide rail 1 comprises a first guide channel 7 which extends along a center axis L_7. In the present case, the center axis L_7 is of straight configuration, with the result that the center axis L_7 can also be called the longitudinal axis of the first guide channel 7. It is also fundamentally conceivable, however, that the center axis L_7 has a shape which differs from straight.

The first guide channel 7 is delimited by a first wall 32 and a second wall 33. The spacing between the first wall 32 and the second wall 33 is substantially constant at least in portions.

A first holding portion 15 is arranged in a radial overlap with respect to the first guide channel 7 and is connected to the first guide channel 7 in such a way that the first guide element 3 of the first sliding door 2 can be guided from the first guide channel 7 into the first holding portion 15. The first holding portion 15 is delimited by way of a bearing surface 16, with which the first guide element 3 of the first sliding door 2 can be brought into contact. Therefore, the movement of the first guide element 3 and respectively the first sliding door 2 can be limited by way of the bearing surface 16. In this regard, the bearing surface 16 can also be called a bounding stop.

A second holding portion 15′ is arranged in a radial overlap with respect to the first guide channel 7, and is connected to the first guide channel 7 in such a way that the first guide element 3′ of the second sliding door 2′ can be guided from the first guide channel 7 into the second holding portion 15′. Here, the arrangement of the respective holding portions in the radial overlap with respect to the first guide channel 7 is to be understood in such a way that the respective holding portion is arranged at least partially in a plane which is arranged at a right angle with respect to the center axis L_7 of the first guide channel 7.

The first holding portion 15 is arranged spaced apart from the first guide channel 7 in the radial direction with regard to the center axis L_7 of the first guide channel 7. The second holding portion 15′ is arranged spaced apart from the first guide channel 7 in the radial direction with regard to the center axis L_7 of the first guide channel 7. In the present case, the first holding portion 15 and the second holding portion 15′ are arranged spaced apart by the same amount from the first guide channel 7 in the radial direction with regard to the center axis L_7 of the first guide channel 7. It is also conceivable, however, that the first holding portion 15 and the second holding portion 15′ are arranged spaced apart by different amounts from the first guide channel 7 in the radial direction with regard to the center axis L_7 of the first guide channel 7.

The first holding portion 15 and the second holding portion 15′ are arranged spaced apart from one another along the center axis L_7 of the first guide channel 7. In the present case, the first holding portion 15 and the second holding portion 15′ are configured so as to be separated spatially from one another. It is fundamentally also conceivable, however, that the first holding portion 15 and the second holding portion 15′ are connected, merge into one another and/or are configured integrally with one another.

The second holding portion 15′ is delimited by way of a bearing surface 16′, with which the first guide element 3′ of the second sliding door 2′ can be brought into contact. Therefore, the movement of the first guide element 3′ and respectively the second sliding door 2′ can be delimited by way of the bearing surface 16′. In this regard, the bearing surface 16′ can also be called a bounding stop.

The first guide channel 7 is connected via a first transfer portion 17 to the first holding portion 15. Here, the first transfer portion 17 extends through the second wall 33 of the guide channel 7. The second wall 33 is therefore interrupted in the region of the first transfer portion 17. In other words, the second wall 33 has a first aperture in the region of the first transfer portion 17.

The first guide channel 7 is connected via a second transfer portion 17′ to the second holding portion 15′. Here, the second transfer portion 17′ extends through the second wall 33 of the guide channel 7. The second wall 33 is therefore interrupted in the region of the second transfer portion 17′. In other words, the second wall 33 has a second aperture in the region of the second transfer portion 17′. In the present case, the second aperture is arranged spaced apart from the first aperture in the direction of the center axis L_7. It is also conceivable, however, that the first aperture and the second aperture merge into one another and, in particular, are configured integrally.

The guide rail 1 is of mirror-symmetrical configuration with regard to a center plane E_M which can also be called the plane of symmetry. In the present case, the center plane E_M is arranged orthogonally with respect to the closing plane E_S. In this regard, the first holding portion 15 is of mirror-symmetrical configuration with respect to the second holding portion 15′, and the first transfer portion 17 is of mirror-symmetrical configuration with respect to the second transfer portion 17′.

The guide rail 1 comprises a first diverter element 19 which is arranged such that it can be pivoted about a pivot axis L_S. Here, the diverter element 19 can be pivoted about the pivot axis L_S into an open position and into a closed position. The pivot axis L_S is arranged parallel to the rotational axis L_D3 of the first guide element 3 of the first sliding door 2. The pivot axis L_S of the diverter element 19 is arranged in a skewed and orthogonal manner with respect to the center axis L_7 of the guide channel 7. In addition, the pivot axis L_S of the diverter element 19 is arranged outside the first guide channel 7. Here, the pivot axis L_S is formed by way of a connecting element 26 which is connected to a rail center module 28.

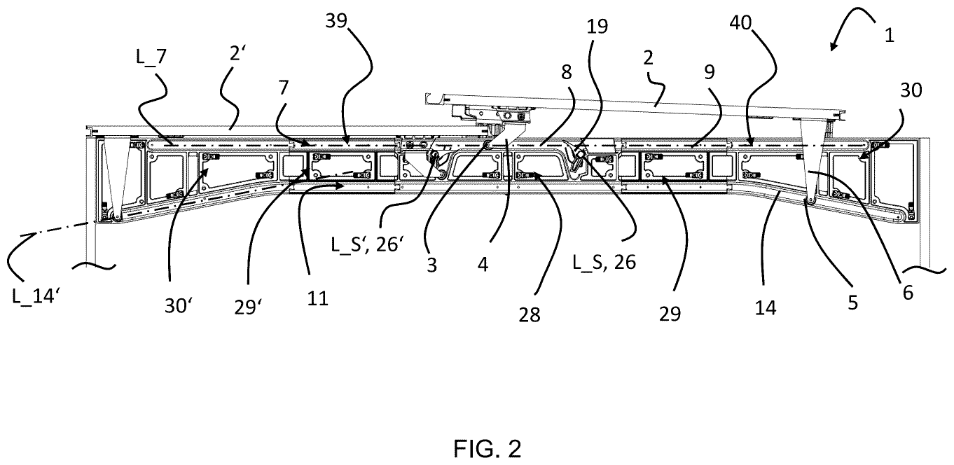

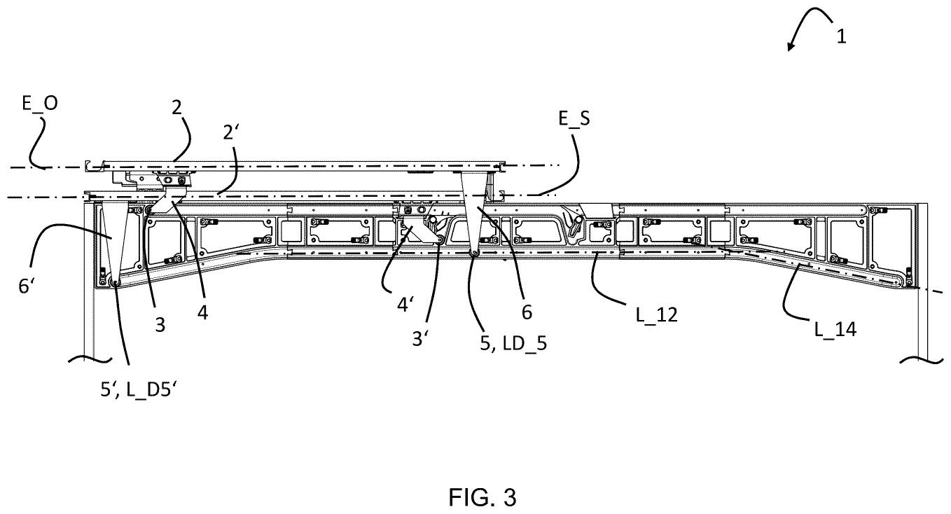

In the open position which is shown, for example, for the first diverter element 19 in FIGS. 2, 3 and 6, the first diverter element 19 divides the first guide channel 7 into a first channel region 39 and a second channel region 40. In FIGS. 2 and 3, for example, the first guide element 3 of the first sliding door 2 is arranged in the first channel region 39. The first channel region 39 is therefore situated in FIGS. 2 and 3 to the left of the first diverter element 19, and the second channel region 40 is situated to the right of the first diverter element 19, without being restricted hereto. Transferring of the first guide element 3 of the first sliding door 2 from the first channel region 39 into the second channel region 40 is blocked by the first diverter element 19 in the open position of the first diverter element 19. Here, the first channel region 39 is connected to the holding portion 15 in such a way that the first guide element 3 of the first sliding door 2 can be transferred from the first channel region 39 into the holding portion 15.

A first spring element 27 loads the first diverter element 19 with a first spring force, with the result that the diverter element 19 is pivoted by the first spring force into the open position. Therefore, the first diverter element 19 remains in the open position in the unloaded state. There is, for example, an unloaded state of the first diverter element 19 when the first guide element 3 is arranged in the first channel region 39. A stop can be provided here which limits the pivoting movement of the first diverter element 19. In particular, this stop can be formed by way of the first wall 32 of the first guide channel 7.

In the closed position, the first diverter element 19 releases the guide channel 7 in such a way that the first channel region 39 and the second channel region 40 are connected to one another. The first guide element 3′ of the second sliding door 3′ can be transferred from the first channel region 39 into the second channel region 40 in the closed position of the first diverter element 19. In the closed position of the first diverter element 19, the guide channel 7 is separated from the holding portion 15 by way of the first diverter element 19.

The first diverter element 19 comprises a separating portion 20 and an actuating portion 23 which are arranged transversely with respect to one another and are connected to one another in the region of the pivot axis L_S. The first diverter element 19 is of L-shaped configuration.

The separating portion 20 is arranged in the guide channel 7 in the open position of the first diverter element 19. In the closed position of the first diverter element 19, the separating portion 20 forms a portion of the second wall 33 of the first guide channel 7 in the region of the first aperture. To this end, the separating portion 20 has a straight channel wall surface 22 which forms the portion of the second wall 33 of the first guide channel 7 in the region of the first aperture in the closed position of the diverter element 19.

In addition, the separating portion 20 has a concave transfer surface 21 which is arranged on a side of the separating portion 20 which lies opposite the channel wall surface 22. In the open position of the diverter element 19, the concave transfer surface 21 delimits a transfer channel 36, via which the first guide element 3 of the first sliding door 2 can be transferred from the guide channel 7, in particular, from the first channel region 39, into the holding portion 15. Here, the transfer channel 36 is delimited in portions by the guide channel 7 and the transfer portion 17.

The actuating portion 23 of the first diverter element 19 is arranged outside the guide channel 7 in the open position of the diverter element 19. In the closed position of the diverter element 19, the actuating portion 23 delimits the holding portion 15. On one side, the actuating portion 23 comprises a concave transfer surface 24 and a straight holding portion bounding surface 25 which delimits the first holding portion 15 in the closed position of the first diverter element 19.

Together with the concave transfer surface 21 of the separating portion 20, the concave transfer surface 24 of the actuating portion 23 forms a concave actuating contour of the first diverter element 19 which delimits the transfer channel 36 in the open position of the diverter element 19.

During the transfer of the first sliding door 2 out of the open position into the closed position, the first guide element 3 is first guided in the first channel region 39. Subsequently, the first guide element 3 runs against the actuating contour of the first diverter element 19. On account of the concave configuration of the actuating contour, the first guide element 3 is repelled radially with regard to the center axis L_7 and is moved via the transfer channel 36 and the transfer portion 17 in the direction of the first holding portion 15.

The contact force which acts between the first guide element 3 and the first diverter element 19 first causes an opening moment which holds the first diverter element 19 in the open position. The force action line of the stated contact force migrates in the direction of the first pivot axis L_S and beyond the latter, on account of the concave configuration of the actuating contour, with a continuing movement of the first guide element 3 in the direction of the first holding portion 15. After the force action line and the first pivot axis L_S have intersected, the contact force causes a closing moment which pivots the first diverter element 19 into the closed position. As a result, the actuating portion 23 is pivoted out of the region of the first holding portion 15 and releases the latter, with the result that the first guide element 3 can enter into the holding portion 15. The guide element 3 can subsequently be moved as far as contact with the first bearing surface 16. In addition, as a result of the closing moment, the separating portion 20 is pivoted out of the guide channel 7, with the result that the first channel region and the second channel region are connected to one another.

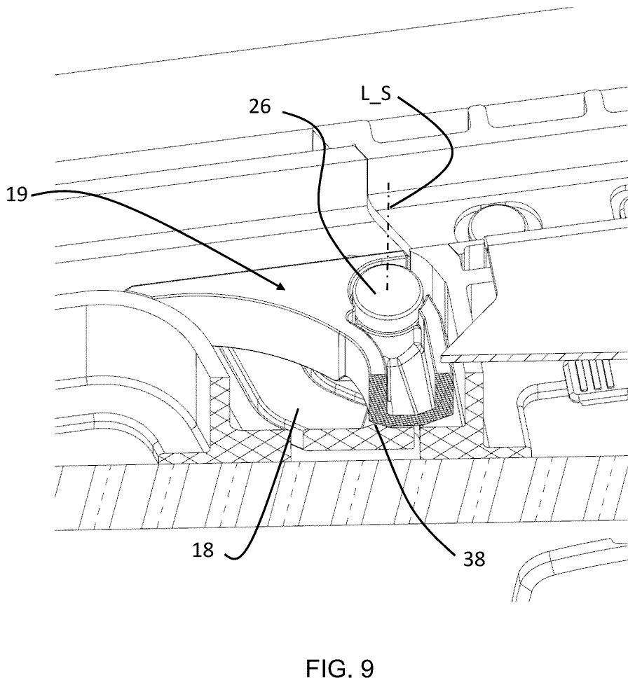

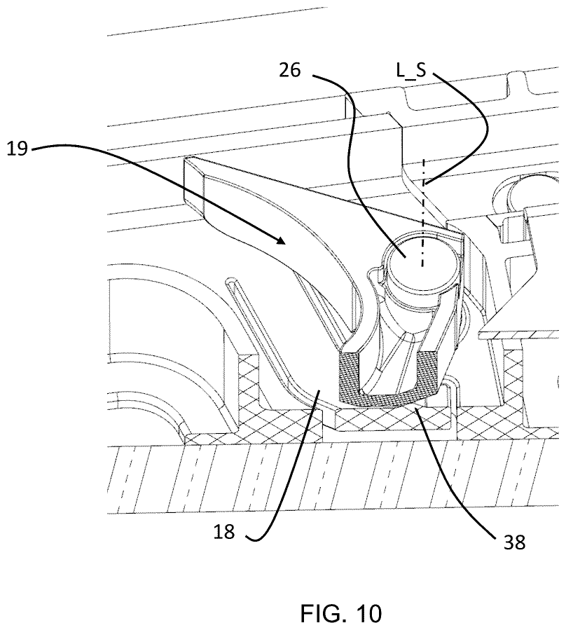

In addition, the guide rail 1 comprises a second spring element 18 which is configured in the present case as a spring clip which extends from the first guide channel 7 into the transfer portion 17. At the free end, the spring clip has a hook portion 38 which extends in the direction of the pivot axis L_S from the spring clip. In the closed position of the first diverter element 19, the first diverter element 19 is in contact with the hook portion 38, with the result that the first diverter element 19 is held in the closed position by the hook portion 38, as can be seen, in particular, from FIG. 9. If the first diverter element 19 is pivoted out of the closed position in the direction of the open position, the second spring element 18 is first deformed by the first diverter element 19, with the result that the first diverter element 19 can be guided through into the open position. In the open position, the first diverter element 19 bears against the first wall 32 of the guide channel 7, and is held in the open position by the hook portion 38 of the second spring element 18, as can be seen, in particular, from FIG. 10.

The second spring element 18 is in contact at least in portions with the first diverter element 19 over the pivoting path of the first diverter element 19 from the closed position into the open position, and loads the first diverter element 19 with a second spring force, with the result that a frictional connection is established between the second spring element 18 and the first diverter element 19. Here, the frictional force acts as a damping force with regard to the pivoting movement of the first diverter element 19. In the present case, the second spring element 18 is in the open position, and is in contact with the actuating portion 23 in the closed position. It is conceivable here that the second spring element 18 is not in contact with the first diverter element 19 in an intermediate position between the open position and the closed position. It is likewise fundamentally conceivable that the second spring element 18 is not in contact with the first diverter element 19 in one of the open position and the closed position.

In addition, it is conceivable that, during the transfer of the first guide element 3, the first guide element 3 comes into contact at least in regions with the spring clip in the region of the transfer portion 17. As a result, the spring clip can be moved away from the first diverter element 19, with the result that the frictional force between the spring clip and the first diverter element 19 is varied or decreased.

The guide rail 1 comprises a second diverter element 19′ which divides the first guide channel 7 into a third channel region and a fourth channel region in the open position, wherein the third channel region is connected to the second holding portion 15′ in such a way that the first guide element 3′ of the second sliding door 2′ can be transferred from the third channel region into the second holding portion 15′. The second diverter element 19′ releases the first guide channel 7 in the closed position in such a way that the first guide element 3 of the first sliding door 2 can be guided from the third channel region into the fourth channel region. The second diverter element 19′ is configured and arranged in a mirror-symmetrical manner with respect to the first diverter element 19 with regard to the center plane E_M. In this regard, what was stated above within the context of the first diverter element 19 applies analogously to the second diverter element 19′. Here, identical or corresponding features are labeled in the Figs. with the same reference signs together with an apostrophe.

The first channel region, defined by way of the first diverter element 19 in the open position, and the third channel region, defined by way of the second diverter element 19′ in the open position, overlap in a region between the first diverter element 19 and the second diverter element 19′.

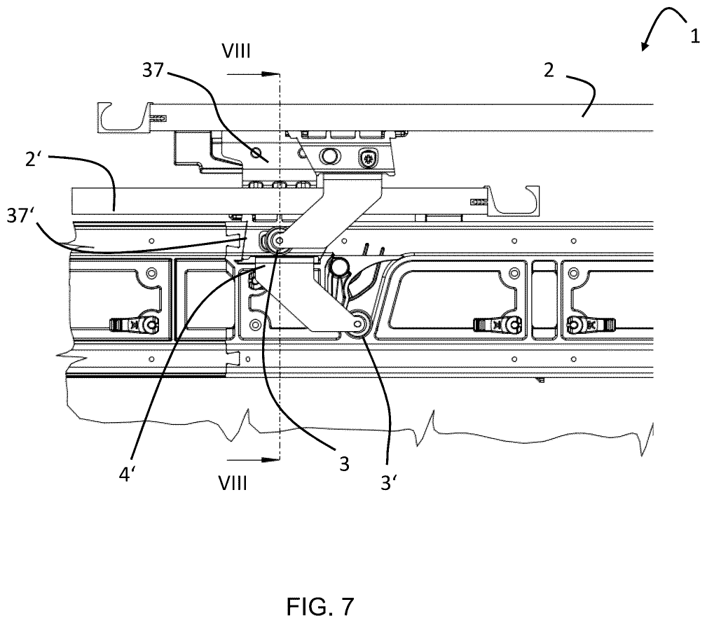

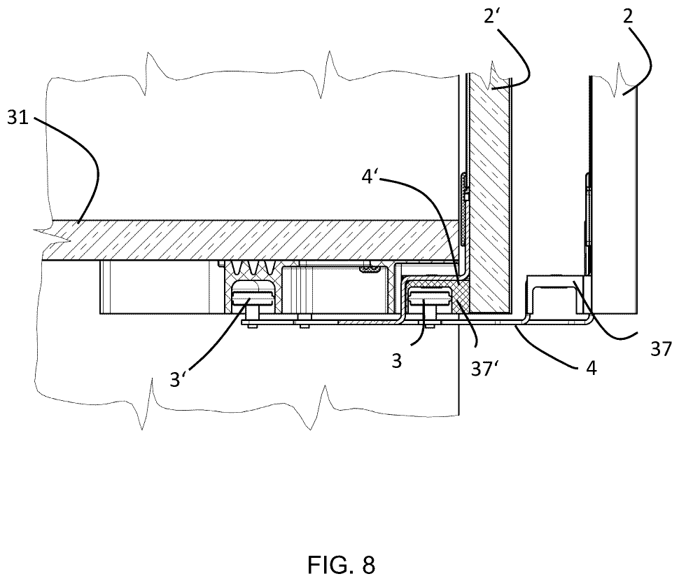

As results, in particular, from the joint consideration of FIGS. 7 and 8, the first holding element 4′ of the second sliding door 2′ has a transfer portion 37′ which is configured in such a way that the first guide element 3 of the first sliding door 2 can be guided past or through the first holding element 4′ of the second sliding door 2′.

In addition, the guide rail 1 comprises a second guide channel 11 which is delimited by a first wall 34 and a second wall 35. The second guide element 5 of the first sliding door 2 and the second guide element 5′ of the second sliding door 2′ can be guided in the second guide channel 11. The second guide channel 11 is arranged spaced apart from the first guide channel 7 with regard to the center axis L_7. Here, the first holding portion 15 and the second holding portion 15′ are arranged between the first guide channel 7 and the second guide channel 11.

The second guide channel 11 is formed by a center portion 12, a first intermediate portion 13, a second intermediate portion 13′, a first end portion 14 and a second end portion 14′. It goes without saying that the first intermediate portion 13 and the second intermediate portion 13′ are optional and, as an alternative, the guide rail 1 can also comprise more than a first intermediate portion 13 and a second intermediate portion 13′.

The center portion 12, the first intermediate portion 13 and the second intermediate portion 13′ extend along the center axis L_12. The center axis L 12 is of straight configuration in the present case. It is fundamentally also conceivable here that the center axis L_12 has a shape which differs from straight. The center axis L_12 is arranged parallel to the center axis L_7 of the first guide channel 7.

The first end portion 14 extends along a first end axis L_14, and the second end portion 14′ extends along a second end axis L_14′. The first end axis L_14 and the second end axis L_14′ are arranged transversely with respect to the center axis L_12 and each enclose an acute angle with the latter.

The second guide channel 11 can have a radius in the respective region of the intersection points of the center axis L_12 with the first end axis L_14 and the second end axis L_14′.

The guide rail 1 is of modular construction and comprises a rail center module 28, a first rail intermediate module 29, a second rail intermediate module 29′, a first rail end module 30 and a second rail end module 30′ here. It goes without saying here that the first rail intermediate module 29 and the second rail intermediate module 29′ are fundamentally optional. It is fundamentally also conceivable, however, that the guide rail 1 comprises more than two rail intermediate modules.

The rail center module 28 is connected at a first end to the first rail intermediate module 29 and at a second end which lies opposite the first end to the second rail intermediate module 29′. In addition, the rail intermediate module 29 is connected to the first rail end module 30, and the second rail intermediate module 29′ is connected to the second rail end module 30′.

The rail center module 28 comprises a center portion 8 of the first guide channel 7 and the center portion 12 of the second guide channel 11. The first rail intermediate module 29 comprises a first intermediate portion 9 of the first guide channel 7 and the first intermediate portion 13 of the second guide channel 11. The second rail intermediate module 29′ comprises a second intermediate portion 9′ of the first guide channel 7 and the second intermediate portion 13′ of the second guide channel 11. The first rail end module 30 comprises a first end portion 10 of the first guide channel 7 and the first end portion 14 of the second guide channel 11. The second rail end module 30′ comprises a second end portion 10′ of the first guide channel 7 and the second end portion 14′ of the second guide channel 11.

The first guide channel 7 is formed by the center portion 8, the first intermediate portion 9, the second intermediate portion 9′, the first end portion 10 and the second end portion 10′.

### LIST OF REFERENCE SIGNS

1 Guide rail
2 Sliding door
3 Guide element
4 Holding element
5 Guide element
6 Holding element
7 Guide channel
8 Center portion
9 Intermediate portion
10 End portion
11 Guide channel
12 Center portion
13 Intermediate portion
14 End portion
15 Holding portion
16 Bearing surface
17 Transfer portion
18 Spring element
19 Diverter element
20 Separating portion
21 Transfer surface
22 Channel wall surface
23 Actuating portion
24 Transfer surface
25 Holding portion bounding surface
26 Connecting element
27 Spring element
28 Rail center module
29 Rail intermediate module
30 Rail end module
31 Furniture item
32 Wall
33 Wall
34 Wall
35 Wall
36 Transfer channel
37 Transfer portion
38 Hook portion
39 Channel region
40 Channel region
L_7 Center axis
L_12 Center axis
L_14 Center axis
L_S Pivot axis
L_D Rotational axis
E_S Closing plane
E_O Opening plane
E_M Symmetry plane

What is claimed is:

1. A guide rail for a sliding door with a guide element, comprising:
a guide channel which extends along a center axis and in which the guide element of the sliding door is configured to be guided;
a holding portion;
a diverter element configured to be pivoted about a pivot axis into an open position and into a closed position;
wherein the diverter element divides the guide channel into a first channel region and a second channel region in the open position;
wherein the first channel region is connected to the holding portion wherein the guide element of the sliding door can be transferred from the first channel region into the holding portion; and
wherein the diverter element releases the guide channel in the closed position wherein the first channel region and the second channel region are connected to one another.

2. The guide rail as claimed in claim 1, wherein the holding portion is arranged in a radial overlap with respect to the guide channel with regard to the center axis.

3. The guide rail as claimed in claim 1, wherein the diverter element is configured to be pivoted from the open position into the closed position by way of the guide element.

4. The guide rail as claimed in claim 1, wherein the pivot axis of the diverter element is arranged in a skewed manner with respect to the center axis of the guide channel.

5. The guide rail as claimed in claim 1, wherein the pivot axis of the diverter element is arranged outside the guide channel.

6. The guide rail as claimed in claim 1, wherein the diverter element comprises a separating portion which is arranged in the guide channel in the open position and forms a portion of a wall of the guide channel in the closed position.

7. The guide rail as claimed in claim 6, wherein the separating portion has a concave transfer surface and a straight channel wall surface, wherein the concave transfer surface delimits, in the open position, a transfer channel, via which the guide element can be transferred from the guide channel into the holding portion, and the straight channel wall surface forms the portion of the wall of the guide channel in the closed position.

8. The guide rail as claimed in claim 1, wherein the diverter element comprises an actuating portion which is arranged outside the guide channel in the open position and delimits the holding portion in the closed position.

9. The guide rail as claimed in claim 8, wherein the actuating portion has a concave transfer surface and a straight holding portion bounding surface, wherein the concave transfer surface of the actuating portion forms, together with the concave transfer surface of the separating portion, an actuating contour which delimits the transfer channel in the open position, and the straight holding portion bounding surface delimits the holding portion in the closed position.

10. The guide rail as claimed in claim 1, wherein a first spring element loads the diverter element with a first spring force, with the result that the diverter element is pivoted into the open position by the first spring force.

11. The guide rail as claimed in claim 1, wherein a second spring element which is in contact with the diverter element in the open position of the diverter element wherein the diverter element is held in the open position by the second spring element; and/or which is in contact with the diverter element in the closed position of the diverter element wherein the diverter element is held in the closed position by the second spring element.

12. The guide rail as claimed in claim 11, wherein the second spring element has a hook portion which is in contact with the diverter element in the open position of the diverter element wherein the diverter element is held in the open position by the hook portion; and/or which is in contact with the diverter element in the closed position of the diverter element wherein the diverter element is held in the closed position by the hook portion.

13. The guide rail as claimed in claim 12, wherein the second spring element is configured as a spring clip which has the hook portion at a free end.

14. The guide rail as claimed in claim 1, wherein a guide element of a further sliding door can be guided in the guide channel, in that a further holding portion is provided, in that a further diverter element is provided which can be pivoted about a further pivot axis into an open position and into a closed position, wherein the pivoting from the open position into the closed position takes place in the case of the further diverter element in the opposite direction to the pivoting of the diverter element, in that the diverter element divides the guide channel into a third channel region and a fourth channel region in the open position, wherein the third channel region is connected to the further holding portion wherein the guide element of the further sliding door can be transferred from the third channel region into the further holding portion, and in that the further diverter element releases the guide channel in the closed position wherein the third channel region is connected to the fourth channel region.

15. The guide rail as claimed in claim 1, wherein a further guide channel which has a center portion, which is arranged parallel to and spaced apart from the center axis of the one guide channel, and a first end portion and a second end portion which are each arranged spaced apart from and transversely with respect to the center axis of the one guide channel, wherein a further guide element of the sliding door and/or a further guide element of the further sliding door can be guided in the further guide channel.

16. A guide rail for a sliding door with a guide element, comprising:
a guide channel which extends along a center axis and in which the guide element of the sliding door can be guided;
a holding portion;
a diverter element which can be pivoted about a pivot axis into an open position and into a closed position;
wherein the diverter element divides the guide channel into a first channel region and a second channel region in the open position;
wherein the first channel region is connected to the holding portion wherein the guide element of the sliding door can be transferred from the first channel region into the holding portion;
wherein the diverter element releases the guide channel in the closed position wherein the first channel region and the second channel region are connected to one another;
wherein a further guide channel is provided which has a center portion, which is arranged parallel to and spaced apart from the center axis of the one guide channel, and a first end portion and a second end portion which are each arranged spaced apart from and transversely with respect to the center axis of the one guide channel; and
wherein a further guide element of the sliding door and/or a further guide element of the further sliding door can be guided in the further guide channel.
